(19) United States
(12) Patent Application Publication
(10) Pub. No.: US 2025/0002678 A1
(43) Pub. Date: Jan. 2, 2025

(54) POLYAMIDE COMPOSITIONS COMPRISING RECYCLED CARBON FIBERS AND USES THEREOF

(71) Applicant: ARKEMA FRANCE, COLOMBES (FR)

(72) Inventors: Guillaume VINCENT, Jiangsu (CN); Mathieu SABARD, Serquigny (FR)

(73) Assignee: ARKEMA FRANCE, COLOMBES (FR)

(21) Appl. No.: 18/710,871

(22) PCT Filed: Nov. 15, 2022
(86) PCT No.: PCT/FR2022/000110

§ 371 Date: May 16, 2024

(30) Foreign Application Priority Data
Nov. 17, 2021 (FR) FR2112118

(51) Int. Cl. C08K 3/04; B29C 45/00; B29K 77/00; B29K 307/04; C08K 7/06; C08K 9/08

(52) U.S. Cl. CPC C08K 3/04; B29C 45/0005; C08K 9/08; B29K 2077/10; B29K 2307/04; B29K 2995/0089; C08K 7/06; C08K 2201/004

(57) ABSTRACT

The present invention relates to a molding composition comprising, by weight: a) from 50% to 99% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight, b) from 1% to 50% of recycled carbon fibers exhibiting a mean length of less than or equal to 6 mm before compounding, said recycled carbon fibers being surface-coated (sized) with a polyamide, in particular an aliphatic polyamide, c) from 0% to 5% of at least one additive, the sum of the components a), b) and c) being equal to 100%.

The invention relates to polyamide compositions comprising recycled carbon fibers and to their uses.

### PRIOR ART

In sports-related applications, polyamides and in particular polyamide 11 (PA 11) reinforced with carbon fibers are well known for their rigidity, their lightness and their high mechanical performance qualities.

Carbon fiber has been used for many years. The reasons why this type of fiber has become indispensable are simple: the manufactured material is extremely strong, durable and ultra-light, characteristics which are highly valued by sports component manufacturers who seek lightness, rigidity and longevity.

Today, the durability of a product is essential for the consumer and has become a key requirement for major sports brands.

A composition reinforced with carbon fibers will have a strong impact on CO₂ emissions, in particular because the production of carbon fibers is energy intensive and because carbon fibers consist of approximately 100% carbon (C).

It is thus necessary to have available compositions reinforced with carbon fibers but exhibiting a much smaller impact on CO₂ emissions, while maintaining high mechanical properties in terms of modulus, stress, elongation and impact strength.

One solution is to use recycled carbon fibers.

Thus, the international application WO 2015/074945 describes a molding mass having the following composition:
(a) from 49% to 97% by weight of at least one plastic substance (A) forming a matrix,
(b) from 3% to 40% by weight of at least one carbon fiber covered with at least one plastic substance (B),
(c) from 0% to 48% by weight of at least one other additive (C),
the sum of the components (a) to (c) representing 100% by weight,
characterized in that the plastic molding mass has a surface resistivity of 1×10⁷ to 1×10²² ohm and a volume resistivity of 1×10⁵ to 1×10²⁰ ohm*m, both determined in accordance with IEC 60093.

The carbon fiber can be recycled or based on cellulose, the plastic (B) is chosen from the group consisting of polyamides, in particular copolyamides, polyesters, in particular copolyesters, polyurethanes, epoxy resins, polyhydroxyethers, acrylic copolymers, and blends or superimposed layers of two or more of these plastics, and the plastic (A) of the component (a) is a thermoplastic chosen from the group composed of acetal resins, liquid crystal polymers, polyacrylates, polymethacrylates, olefinic and cycloolefinic polymers, polyamides, polyamide elastomers, in particular polyesteramides, polyetheramides and polyetheresteramides, polyamide-imides, polyethers, polyaryl ethers, including polyphenyl ethers, polyhydroxyethers, polycarbonates, polysulfones, polyetherimides, polyimides, polyesters, polyester polycarbonates, polyoxyethylenes, polystyrenes, copolymers of styrene, polysulfones, vinyl polymers, such as polyvinyl chloride and polyvinyl acetate, and blends of two or more of the thermoplastics mentioned, or a duroplast chosen from the group composed of melamine resins, phenoplasts, polyester resins, aminoplasts, epoxy resins, polyurethanes, crosslinked polyacrylates, and blends of two or more of the duroplasts mentioned.

Nevertheless, these compositions exhibit the disadvantage of being brittle with an elongation at break of less than 3%.

Some recycled materials may have been detrimentally affected by their history and their experience and thus their performance qualities, in particular mechanical qualities, may be lower in comparison with virgin materials, which does not satisfy the requirements of compositions based on polymers with high performance qualities, such as PA11.

It is thus necessary to have available compositions reinforced with recycled carbon fibers which do not exhibit the abovementioned disadvantages of impact on CO₂ emissions and of loss of mechanical properties.

The present invention thus relates to a molding composition comprising, by weight:
a) from 50% to 99% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight,
b) from 1% to 50% of recycled carbon fibers exhibiting a mean length of less than or equal to 6 mm before compounding and which are surface-coated with a polyamide, in particular an aliphatic polyamide,
c) from 0% to 5% of additives,
the sum of the components a), b) and c) being equal to 100%.

The inventors have thus found, surprisingly, that, by selecting a polyamide exhibiting an appropriate inherent viscosity, and also recycled carbon fibers sized with a polyamide, it was possible to improve the mechanical performance qualities of polyamide formulations and also the CO₂ emissions, in comparison with polyamide formulations reinforced with virgin carbon fibers.

A molding composition is as a general rule prepared by melt blending the various ingredients of it in an extruder, in particular a twin-screw extruder. The compounded material emerges from the extruder in the form of rods which are subsequently cooled and cut into granules.

The term “before compounding” thus means that the recycled carbon fibers which are introduced into the extruder at the time of the processing exhibit a mean length of less than or equal to 6 mm.

### Regarding the Semicrystalline Aliphatic Polyamide (a):

The nomenclature used to define the polyamides is described in the standard ISO 1874-1:2011, “Plastics-Polyamide (PA) molding and extrusion materials-Part 1: Designation”, in particular on page 3 (tables 1 and 2), and is well known to a person skilled in the art.

A semicrystalline polyamide, within the meaning of the invention, denotes a polyamide which exhibits a glass transition temperature (Tg) and a melting point (Tm) which are respectively determined according to the standards ISO 11357-2 and 3:2013, and an enthalpy of crystallization during the stage of cooling at a rate of 20 K/min in DSC measured according to the standard ISO 11357-3 of 2013 of greater than 30 J/g, preferably of greater than 35 J/g.

The polyamide can be a homopolyamide or a copolyamide or a blend of these.

The semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight, is present at from 50% to 99% in the composition, preferably from 60.0% to 90.0%, more preferentially from 60.0% to 80.0% by weight, more preferentially still from 65.0% to 80.0% by weight, each based on the sum of the constituents of the composition.

The mean number of carbon atoms, with respect to the nitrogen atom, is greater than or equal to 6.

Advantageously, the semicrystalline aliphatic polyamide is to the exclusion of PA6 and PA66.

Advantageously, the mean number of carbon atoms, with respect to the nitrogen atom, is greater than or equal to 8, especially greater than or equal to 9, in particular greater than or equal to 10.

Advantageously, the mean number of carbon atoms, with respect to the nitrogen atom, is greater than or equal to 8 and the semicrystalline aliphatic polyamide is to the exclusion of PA612.

In the case of a homopolyamide of PA-X·Y type, the number of carbon atoms per nitrogen atom is the mean of the unit X and of the unit Y.

In the case of a copolyamide, the number of carbons per nitrogen is calculated according to the same principle. The calculation is carried out on a molar pro rata basis from the various amide units.

### In a First Embodiment

In a first alternative form of this first embodiment, the semicrystalline aliphatic polyamide is obtained from the polycondensation of at least one aminocarboxylic acid comprising from 6 to 18 carbon atoms, preferentially from 9 to 18 carbon atoms, more preferentially from 10 to 18 carbon atoms, more preferentially still from 10 to 12 carbon atoms. It can thus be chosen from 6-aminohexanoic acid, 7-aminoheptanoic acid, 8-aminooctanoic acid, 9-aminononanoic acid, 10-aminodecanoic acid, 11-aminoundecanoic acid, 12-aminododecanoic acid, 13-aminotridecanoic acid, 14-aminotetradecanoic acid, 15-aminopentadecanoic acid, 16-aminohexadecanoic acid, 17-aminoheptadecanoic acid, 18-aminooctadecanoic acid.

Preferentially, it is obtained from the polycondensation of a single aminocarboxylic acid.

In a second alternative form of this first embodiment, the semicrystalline aliphatic polyamide is obtained from the polycondensation of at least one lactam comprising from 6 to 18 carbon atoms, preferentially from 9 to 18 carbon atoms, more preferentially from 10 to 18 carbon atoms, more preferentially still from 10 to 12 carbon atoms.

Preferentially, it is obtained from the polycondensation of a single lactam.

In a third alternative form of this first embodiment, the semicrystalline aliphatic polyamide is obtained from the polycondensation of at least one aliphatic diamine comprising from 4 to 36 carbon atoms, advantageously from 6 to 18 carbon atoms, advantageously from 6 to 12 carbon atoms, advantageously from 10 to 12 carbon atoms, and of at least one aliphatic dicarboxylic acid comprising from 4 to 36 carbon atoms, advantageously from 6 to 18 carbon atoms, advantageously from 6 to 12 carbon atoms, advantageously from 10 to 12 carbon atoms.

The aliphatic diamine used to obtain this repeat unit X·Y is an aliphatic diamine which exhibits a linear main chain comprising at least 4 carbon atoms.

This linear main chain may, if appropriate, comprise one or more methyl and/or ethyl substituents; in this latter configuration, the term “branched aliphatic diamine” is used. In the case where the main chain does not comprise any substituent, the aliphatic diamine is referred to as “linear aliphatic diamine”.

Whether or not it comprises methyl and/or ethyl substituents on the main chain, the aliphatic diamine used to obtain this repeat unit X·Y comprises from 4 to 36 carbon atoms, advantageously from 4 to 18 carbon atoms, advantageously from 6 to 18 carbon atoms, advantageously from 6 to 14 carbon atoms.

When this diamine is a linear aliphatic diamine, it then corresponds to the formula H₂N—(CH₂)ₓ—NH₂ and can be chosen, for example, from butanediamine, pentanediamine, hexanediamine, heptanediamine, octanediamine, nonanediamine, decanediamine, undecanediamine, dodecanediamine, tridecanediamine, tetradecanediamine, hexadecanediamine, octadecanediamine and octadecenediamine. The linear aliphatic diamines which have just been mentioned can be all biobased within the meaning of the standard ASTM D6866.

When this diamine is a branched aliphatic diamine, it can in particular be 2-methylpentanediamine, 2-methyl-1,8-octanediamine or (2,2,4- or 2,4,4-)trimethylhexanediamine.

The dicarboxylic acid can be chosen from linear or branched aliphatic dicarboxylic acids.

When the dicarboxylic acid is aliphatic and linear, it can be chosen from succinic acid (4), pentanedioic acid (5), adipic acid (6), heptanedioic acid (7), octanedioic acid (8), azelaic acid (9), sebacic acid (10), undecanedioic acid (11), dodecanedioic acid (12), brassylic acid (13), tetradecanedioic acid (14), hexadecanedioic acid (16), octadecanedioic acid (18), octadecenedioic acid (18), eicosanedioic acid (20), docosanedioic acid (22) and fatty acid dimers containing 36 carbons.

The abovementioned fatty acid dimers are dimerized fatty acids obtained by oligomerization or polymerization of unsaturated monobasic fatty acids having a long hydrocarbon chain (such as linoleic acid and oleic acid), as described in particular in the document EP 0 471 566.

In a fourth alternative form of this first embodiment, the semicrystalline aliphatic polyamide is obtained from a mixture of these three alternative forms.

### In a Second Embodiment

In a first alternative form of this second embodiment, the semicrystalline aliphatic polyamide is obtained from the polycondensation of at least one aminocarboxylic acid comprising from 6 to 18 carbon atoms, preferentially from 8 to 12 carbon atoms, more preferentially from 10 to 12 carbon atoms.

Preferentially, it is obtained from the polycondensation of a single aminocarboxylic acid.

In a second alternative form of this second embodiment, the semicrystalline aliphatic polyamide is obtained from the polycondensation of at least one lactam comprising from 6 to 18 carbon atoms, preferentially from 8 to 12 carbon atoms, more preferentially from 10 to 12 carbon atoms.

Preferentially, it is obtained from the polycondensation of a single lactam.

In a third embodiment, said semicrystalline polyamide is chosen from PA610, PA612, PA1010, PA1012, PA1212, PA11 and PA12, in particular PA1010, PA1012, PA1212, PA11, PA12.

Advantageously, said semicrystalline polyamide is chosen from PA11 and PA12, in particular PA11.

In one embodiment, said semicrystalline polyamide of said composition consists of at least 30% by weight, in particular of at least 50% by weight, of recycled semicrystalline polyamide.

### Regarding the Carbon Fibers

The carbon fibers recycled in the semicrystalline aliphatic polyamide molding composition according to the invention are preferably present at from 1.0% to 50.0% by weight, preferably from 10.0% to 40.0% by weight, more preferentially from 20.0% to 40.0% by weight, more preferentially still from 25.0% to 40.0% by weight, each based on the sum of the constituents of the composition.

The recycled carbon fibers used in the semicrystalline aliphatic polyamide molding composition can be provided in the form of chopped (or short) fibers or in the form of bundles of chopped (or short) fibers or in the form of ground carbon fibers.

Before compounding, the carbon fibers are preferentially chopped (or short) carbon fibers and have a mean length of from 0.1 to 6 mm, in particular from 2 to 6 mm.

Before compounding, the ground carbon fibers have a mean length of from 50 μm to 400 μm.

After compounding, in the composition to be molded, the ground carbon fibers have a mean length of less than 400 μm.

After compounding, in the composition to be molded, the short carbon fibers have a mean length of from 100 to 600 μm, in particular from 150 to 500 μm.

The recycled carbon fibers used are surface-coated (sizing). A coating (sizing) must be compatible with the plastic matrix in order to ensure good coating, good adhesion and the best possible reinforcing effect.

The polyamide sizing of the recycled carbon fiber can be a semiaromatic polyamide or an aliphatic polyamide or a blend of these.

Advantageously, said polyamide is an aliphatic polyamide.

Advantageously, said aliphatic polyamide is a semicrystalline polyamide, in particular exhibiting a mean number of carbon atoms per nitrogen atom (C/N) of less than or equal to 10, especially of less than or equal to 9, in particular of less than or equal to 8, especially of less than or equal to 6.

In one embodiment, said semicrystalline aliphatic polyamide is chosen from PA6, PA66 and a blend of these.

Examples of aliphatic polyamides, in particular semicrystalline aliphatic polyamides, are given above.

Advantageously, the recycled carbon fibers are sized by said polyamide, in particular said aliphatic polyamide, in a range extending from 0.5% to 6%, especially from 1% to 5%, in particular from 1.5% to 4%, by weight, with respect to the carbon fibers-sizing total.

In one embodiment, the carbon footprint of the recycled carbon fibers is at least halved with respect to the footprint of the virgin carbon fibers as determined according to the LCA (Life Cycle Assessment) method in order to determine the environmental impact according to in particular the international standards ISO 14040:2006, ISO 14044:2006 and/or ISO 14067:2018.

### Regarding the Additives (c)

The additive is optional and of from 0% to 5.0%, in particular from 0.1% to 5.0%, by weight.

The additive is chosen from fillers, glass beads, dyes, stabilizers, plasticizers, surface-active agents, nucleating agents, pigments, brighteners, antioxidants, lubricants, flame retardants, natural waxes and their mixtures.

It is very obvious that the fillers are to the exclusion of recycled or nonrecycled carbon fibers.

Advantageously, the additive is chosen from fillers, dyes, stabilizers, plasticizers, surface-active agents, nucleating agents, pigments, brighteners, antioxidants, flame retardants, natural waxes and their mixtures.

Advantageously, the additive is chosen from dyes, stabilizers, nucleating agents, pigments, brighteners, antioxidants, natural waxes and their mixtures.

By way of example, the stabilizer can be a UV stabilizer, an organic stabilizer or more generally a combination of organic stabilizers, such as an antioxidant of phenol type (for example of the type of that of Irganox 245 or 1098 or 1010 from Ciba-BASF), an antioxidant of phosphite type (for example Irgafos® 126 from Ciba-BASF) and indeed even optionally other stabilizers, such as a HALS, which means Hindered Amine Light Stabilizer (for example Tinuvin 770 from Ciba-BASF), a UV absorber (for example Tinuvin 312 from Ciba), a phosphorus-based stabilizer. Use may also be made of antioxidants of amine type, such as Naugard 445 from Crompton, or also polyfunctional stabilizers, such as Nylostab S-EED from Clariant.

This stabilizer can also be an inorganic stabilizer, such as a copper-based stabilizer. Mention may be made, as examples of such inorganic stabilizers, of copper halides and acetates. Incidentally, other metals, such as silver, can optionally be considered but these are known to be less effective. These copper-based compounds are typically combined with halides of alkali metals, in particular potassium.

By way of example, the plasticizers are chosen from benzenesulfonamide derivatives, such as n-butylbenzenesulfonamide (BBSA); ethyltoluenesulfonamide or N-cyclohexyltoluenesulfonamide; esters of hydroxybenzoic acids, such as 2-ethylhexyl para-hydroxybenzoate and 2-decylhexyl para-hydroxybenzoate; esters or ethers of tetrahydrofurfuryl alcohol, such as oligoethyleneoxytetrahydrofurfuryl alcohol; and esters of citric acid or of hydroxymalonic acid, such as oligoethyleneoxy malonate.

It would not be departing from the scope of the invention to use a mixture of plasticizers.

By way of example, the fillers can be chosen from silica, graphite, expanded graphite, carbon black, kaolin, magnesia, slag, talc, wollastonite, nanofillers (carbon nanotubes), pigments, metal oxides (titanium oxide), metals, advantageously wollastonite and talc, preferentially talc.

### Regarding the Composition

The molding composition is as defined above and comprises, in a first embodiment, by weight:
a) from 50% to 99% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight,
b) from 1% to 50% of recycled carbon fibers exhibiting a mean length of less than or equal to 6 mm before compounding, said recycled carbon fibers being surface-coated (sized) with a polyamide, in particular an aliphatic polyamide,
c) from 0% to 5% of at least one additive,
the sum of the components a), b) and c) being equal to 100%.

Advantageously, it comprises, by weight:
a) from 50% to 98.9% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight,
b) from 1% to 50% of recycled carbon fibers exhibiting a mean length of less than or equal to 6 mm before compounding, said recycled carbon fibers being surface-coated (sized) with a polyamide, in particular an aliphatic polyamide,
c) from 0.1% to 5% of at least one additive,
the sum of the components a), b) and c) being equal to 100%.

According to a first alternative form, it comprises, by weight:
a) from 60% to 90% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight,
b) from 10% to 40% of recycled carbon fibers exhibiting a mean length of less than or equal to 6 mm before compounding, said recycled carbon fibers being surface-coated (sized) with a polyamide, in particular an aliphatic polyamide,
c) from 0% to 5% of at least one additive,
the sum of the components a), b) and c) being equal to 100%.

Advantageously, it comprises, by weight:
a) from 60% to 89.9% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight,
b) from 10% to 40% of recycled carbon fibers exhibiting a mean length of less than or equal to 6 mm before compounding, said recycled carbon fibers being surface-coated (sized) with a polyamide, in particular an aliphatic polyamide,
c) from 0.1% to 5% of at least one additive,
the sum of the components a), b) and c) being equal to 100%.

According to a second alternative form, it comprises, by weight:
a) from 60% to 80% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight,
b) from 20% to 40% of recycled carbon fibers exhibiting a mean length of less than or equal to 6 mm before compounding, said recycled carbon fibers being surface-coated (sized) with a polyamide, in particular an aliphatic polyamide,
c) from 0% to 5% of at least one additive,
the sum of the components a), b) and c) being equal to 100%.

Advantageously, it comprises, by weight:
a) from 60% to 79.9% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight,
b) from 20% to 40% of recycled carbon fibers exhibiting a mean length of less than or equal to 6 mm before compounding, said recycled carbon fibers being surface-coated (sized) with a polyamide, in particular an aliphatic polyamide,
c) from 0.1% to 5% of at least one additive,
the sum of the components a), b) and c) being equal to 100%.

According to a third alternative form, it comprises, by weight:
a) from 60% to 75% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight,
b) from 25% to 40% of recycled carbon fibers exhibiting a mean length of less than or equal to 6 mm before compounding, said recycled carbon fibers being surface-coated (sized) with a polyamide, in particular an aliphatic polyamide,
c) from 0% to 5% of at least one additive,
the sum of the components a), b) and c) being equal to 100%.

Advantageously, it comprises, by weight:
a) from 60% to 74.9% of a semicrystalline aliphatic polyamide exhibiting an inherent viscosity of less than or equal to 1.10, in particular of less than or equal to 1.00, in particular of less than or equal to 0.95, especially of less than or equal to 0.9, as determined according to the standard ISO 307:2007 but while using m-cresol instead of sulfuric acid, a temperature of 20° C. and a concentration of 0.5% by weight,
b) from 25% to 40% of recycled carbon fibers exhibiting a mean length of less than or equal to 6 mm before compounding, said recycled carbon fibers being surface-coated (sized) with a polyamide, in particular an aliphatic polyamide,
c) from 0.1% to 5% of at least one additive,
the sum of the components a), b) and c) being equal to 100%.

In a second embodiment, said composition of the invention consists of the various elements a, b and c, their sum being equal to 100% by weight, which are defined in the first embodiment and of the three alternative forms with their particular embodiment which are defined above.

Whatever the embodiments of the compositions described above, said composition is characterized in that the mechanical properties of it are at least equivalent to those of the same composition but comprising virgin carbon fibers exhibiting a mean length of less than or equal to 6 mm instead of the carbon fibers recycled before the compounding stage, said virgin carbon fibers being surface-coated (sized) by the same polyamide or a polymer other than a polyamide.

In particular, the resilience, as measured by 1 eU Charpy impact on unnotched bars at 23° C., of the compositions according to the invention is greater by more than 10% than that obtained with virgin carbon fibers sized by a polyamide or with carbon fibers recycled but sized by a polymer other than a polyamide.

Advantageously, the elongation at break of the compositions according to the invention is greater by more than 10% than that obtained with virgin carbon fibers sized by a polyamide or with carbon fibers recycled but sized by a polymer other than a polyamide.

In one embodiment, the resilience, as measured by 1 eU Charpy impact on unnotched bars at 23° C., of the compositions according to the invention is greater by more than 10% than that obtained with virgin carbon fibers sized by a polyamide or with carbon fibers recycled but sized by a polymer other than a polyamide.

In another embodiment, the resilience, as measured by 1 eU Charpy impact on unnotched bars at 23° C., and the elongation at break of the compositions according to the invention are greater by more than 10% than those obtained with virgin carbon fibers sized by a polyamide or with carbon fibers recycled but sized by a polymer other than a polyamide.

According to another aspect, the present invention relates to the use of a composition as defined above for the manufacture of articles obtained by injection molding chosen from a sports article, in particular an item of sports footwear, especially a ski boot or a part of a ski boot or a rigid boot with studs, such as a soccer, rugby or American football boot, a hockey boot or a part of a hockey boot, or a running shoe, a golf ball or a part of a golf ball, or a lacrosse stick, a hockey article such as a helmet, and sports articles for the protection of the head, shoulders, elbows, hands, knees, back or shin, such as a helmet, gloves, shoulder pads, elbow pads, knee pads or shin pads.

According to yet another aspect, the present invention relates to the use of a molding composition as defined above for the manufacture of an article for the electronics industry, for the motor vehicle industry, for telecom applications or for the exchange of data, such as for an autonomous vehicle or for applications connected to one another.

According to another aspect, the present invention relates to an article obtained by injection molding of a composition as defined above.

### EXAMPLES

The present invention will now be illustrated by the following examples without, however, being limiting of the invention.

### Preparation of the Compositions of the Invention and Mechanical Properties:

The compositions of table I were prepared by melt blending the polymer granules with the carbon fibers and the additives. This blending was carried out by compounding on a corotating twin-screw extruder with a diameter of 26 mm with a flat temperature profile (T°) at 240° C. The screw speed is 200 rpm and the throughput is 16 kg/h.

The carbon fibers are introduced by side feeding.

The polyamide(s) and the additives are added during the compounding process via the main hopper.

The compositions were subsequently molded on an injection molding machine at a material temperature of 260° C. and a mold temperature of 60° C. in the form of dumbbells or bars in order to study the mechanical properties according to the standards below.

TABLE I

| | CE 1 | CE2 | CE3 | E1 |
|---|---|---|---|---|
| PA11 | 67.84 | 67.84 | 67.84 | 67.84 |
| (i.v. m-cresol = 0.9) | | | | |
| Additives: antioxidants 1.56% | 2.16 | 2.16 | 2.16 | 2.16 |
| and lubricant 0.60%, with | | | | |
| respect to the total weight of | | | | |
| the composition | | | | |
| PAN virgin carbon fiber, sized | 30.00 | | | |
| with polyurethane sizing with a | | | | |
| length of 6 mm and a diameter | | | | |
| of the filament = 7 μm | | | | |
| (Teijin TM Toho Tenax HT C493) | | | | |
| PAN virgin carbon fiber, sized | | 30.00 | | |
| with polyamide sizing with a | | | | |
| length of 6 mm and a diameter | | | | |
| of the filament = 7 μm | | | | |
| (Teijin TM Toho Tenax HT C604) | | | | |
| PAN recycled carbon fiber, sized | | | | 30.00 |
| with polyamide sizing with a | | | | |
| length of 6 mm and a diameter | | | | |
| of the filament = 7 μm | | | | |
| (Procotex CF. OS A) | | | | |
| PAN recycled carbon fiber, sized | | | 30.00 | |
| with polyurethane sizing with a | | | | |
| length of 6 mm and a diameter | | | | |
| of the filament = 7 μm | | | | |
| (Procotex CF.OS.U1) | | | | |
| Tensile modulus (GPa) ISO | 17.1 | 17.3 | 16.9 | 18.3 |
| 527-1: 2012 | | | | |
| Breaking stress (MPa) | 168 | 175 | 163 | 180 |
| Elongation at break (%) | 4 | 4.2 | 3.5 | 4.7 |
| Notched impact according to ISO | 22 | 23 | 20 | 23 |
| 179: 1eA at 23° C., resilience | | | | |
| (kJ/m²) | | | | |
| Notched impact according to ISO | 14 | 15 | 12 | 15 |
| 179: 1eA at −30° C., resilience | | | | |
| (kJ/m²) | | | | |
| 1eU unnotched impact at 23° C., | 83 | 83 | 80 | 95 |
| resilience (kJ/m²) | | | | |
| 1eU unnotched impact at −30° C., | 82 | 83 | 79 | 97 |
| resilience (kJ/m²) | | | | |

CE: Counterexample

### E: Examples of the Invention

The proportions are shown as proportion by weight (%).

The PAN virgin and PAN recycled carbon fibers with polyurethane or polyamide sizing are sold, for example, by Mitsubishi, SGL, ACECA, Teijin, Zoltek or Hexcel.

PA11: synthesized by the applicant company.

The tensile modulus, the elongation at break and the breaking stress were measured at 23° C. according to the standard ISO 527-1:2012 on a dry sample.

The machine used is of Instron 5966 type. The speed of the crosshead is 1 mm/min for the measurement of the modulus and 5 mm/min for the breaking stress and the elongation at break. The
test conditions are 23° C.+/−2° C., on dry samples.

The impact strength was determined according to ISO 179-1:2010 (Charpy impact) on notched and unnotched bars with
dimensions of 80 mm×10 mm×4 mm, at a temperature of 23° C.+/−2° C. under a relative humidity of 50%+/−10% or at −30° C.+/−2° C. under a relative humidity of 50%+/−10%, on dry samples.

The examples and counterexamples above show that the mechanical properties of compositions based on recycled carbon fibers sized with a polyamide are better than those of compositions based on virgin carbon fibers sized with a polyamide or on virgin carbon fibers sized with another polymer.

1. A molding composition comprising, by weight:
a) from 50% to 99% of a semicrystalline aliphatic polyamide exhibiting an inherent viscosity of less than or equal to 1.10, as determined according to the standard ISO 307:2007 but while using m-cresol instead of sulfuric acid, a temperature of 20° C. and a concentration of 0.5% by weight,
b) from 1% to 50% of recycled carbon fibers exhibiting a mean length of less than or equal to 6 mm before compounding, said recycled carbon fibers being surface-coated (sized) with a polyamide,
c) from 0% to 5% of at least one additive,
the sum of the components a), b) and c) being equal to 100%.

2. The molding composition as claimed in claim 1, wherein the semicrystalline aliphatic polyamide (a) is obtained by polycondensation:
of at least one C6 to C18 aminocarboxylic acid, or
of at least one C6 to C18 lactam, or
of at least one C4-C36 diamine Ca with at least one C4-C36 dicarboxylic acid Cb.

3. The molding composition as claimed in claim 1, wherein said polyamide (a) exhibits a mean number of carbon atoms per nitrogen atom of greater than or equal to 8.

4. The molding composition as claimed in claim 3, wherein said polyamide (a) is chosen from PA610, PA612, PA1010, PA1012, PA1212, PA11 and PA12.

5. The molding composition as claimed in claim 1, wherein the resilience, as measured by 1 eU Charpy impact on unnotched bars at 23° C., of said compositions is greater by more than 10% than that obtained with virgin carbon fibers sized by a polyamide or with carbon fibers recycled but sized by a polymer other than a polyamide.

6. The molding composition as claimed in claim 1, wherein the resilience, as measured by 1 eU Charpy impact on unnotched bars at 23° C., and the elongation at break of said compositions are greater by more than 10% than those obtained with virgin carbon fibers sized by a polyamide or with carbon fibers recycled but sized by a polymer other than a polyamide.

7. (canceled)

8. A method of forming an article of manufacture, the method comprising using the molding composition as defined in claim 1 for the article of manufacture.

9. An article obtained by injection molding of the molding composition as defined in claim 1.
